(19) United States
(12) Patent Application Publication
(10) Pub. No.: US 2016/0139488 A1
(43) Pub. Date: May 19, 2016

(54) LASER OSCILLATION MECHANISM

(71) Applicant: DISCO CORPORATION, Tokyo (JP)

(72) Inventor: Keiji Nomaru, Tokyo (JP)

(21) Appl. No.: 14/933,240

(22) Filed: Nov. 5, 2015

(30) Foreign Application Priority Data
Nov. 14, 2014 (JP) 2014-231419

(51) Int. Cl. G02F 1/33; G02B 5/18; H01S 3/00

(52) U.S. Cl. CPC G02F 1/33; H01S 3/0071; G02B 5/1814; H01S 3/0085

(57) ABSTRACT

A laser oscillation mechanism includes a pulse laser oscillator which oscillates a pulse laser beam, and an optical path changing unit which changes an angle of an optical path of the pulse laser beam oscillated by the pulse laser oscillator. The optical path changing unit is configured from an acousto-optic deflection unit including an acousto-optic device for changing the optical path of the pulse laser beam oscillated by the pulse laser oscillator within an effective region, and a volume Bragg grating which excludes, from among pulse laser beams obtained by changing the angle of the optical path of the pulse laser beam by passing through the acousto-optic device, a pulse laser beam desired to be eliminated by refraction from within the effective region.

### BACKGROUND OF THE INVENTION

1. Field of the Invention

The present invention relates to a laser oscillation mechanism incorporated in a laser processing apparatus which performs laser processing for a workpiece or a like apparatus.

2. Description of the Related Art

In a semiconductor device fabrication process, a plurality of regions are partitioned by scheduled division lines arrayed in a grating on the surface of a semiconductor wafer having a substantially circular disk shape, and a device such as an IC or an LSI is formed in each of the partitioned regions. Then, by cutting the semiconductor wafer along the scheduled division lines, the regions in each of which a device is formed are divided to fabricate individual semiconductor chips.

In order to implement downsizing and enhancement in function of an apparatus, a module structure is practically used in which a plurality of semiconductor chips are stacked and electrodes of the stacked semiconductor chips are connected to each other. In the module structure, a through-hole is formed at a location of a semiconductor wafer at which each electrode is formed and a conductive material such as aluminum connected to the electrode is embedded into the through-hole to form a via hole.

A method has been proposed in which such a through-hole as described above is formed by irradiating a laser beam. As a laser processing apparatus for forming a through-hole in this manner, a technology has been proposed in which laser beam irradiation means including acousto-optic deflection means for which an acousto-optic device (AOD) is used is incorporated and an optical path is changed when a laser beam oscillated by the laser beam oscillation means passes the acousto-optic device (AOD) such that the laser beam is irradiated at the same processing position while a workpiece is processing-fed (for example, refer to Japanese Patent Laid-Open No. 2008-290086).

### SUMMARY OF THE INVENTION

However, the angle of an optical path changed by an acousto-optic device (AOD) is approximately 2 milliradians to 3 milliradians. Therefore, laser beam absorption means must be disposed at a position spaced by 1 m to 2 m from the acousto-optic device (AOD) in order to remove a laser beam of zero-order light which has passed the acousto-optic device (AOD). Therefore, there is a problem the size of the apparatus increases.

Therefore, it is an object of the present invention to provide a laser oscillation mechanism wherein the angle of an optical path of a laser beam oscillated by a laser oscillator can be changed by acousto-optic deflection means for which an acousto-optic device (AOD) is used without increasing the size of an apparatus.

In accordance with an aspect of the present invention, there is provided a laser oscillation mechanism comprising: a pulse laser oscillator configured to oscillate a pulse laser beam; and optical path changing means for changing an angle of an optical path of the pulse laser beam oscillated by the pulse laser oscillator, wherein the optical path changing means includes acousto-optic deflection means including an acousto-optic device for changing the optical path of the pulse laser beam oscillated by the pulse laser oscillator within an effective region, and a volume Bragg grating configured to exclude, from among pulse laser beams obtained by changing an angle of the optical path of the pulse laser beam by passing through said acousto-optic device, a pulse laser beam desired to be eliminated by refraction from within the effective region.

The optical path changing means which configures the laser oscillation mechanism according to the present invention is configured from the acousto-optic deflection means which uses the acousto-optic device for changing the optical path of the pulse laser beam oscillated by the pulse laser oscillator within the effective region, and the volume Bragg grating (VBG) configured to exclude, from among pulse laser beams obtained by changing the angle of the optical path of the pulse laser beam by passing through the acousto-optic device, a pulse laser beam desired to be eliminated by refraction from within the effective region. Therefore, the volume Bragg grating can be disposed in a neighboring relationship with the acousto-optic device which configures the acousto-optic deflection means. Therefore, upsizing of the apparatus can be prevented.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view of a laser processing apparatus in which a laser oscillation mechanism according to an embodiment of the present invention is incorporated; and

FIG. 2 is a block diagram of laser beam irradiation means in which the laser oscillation mechanism is incorporated.

### DETAILED DESCRIPTION OF THE PREFERRED EMBODIMENT

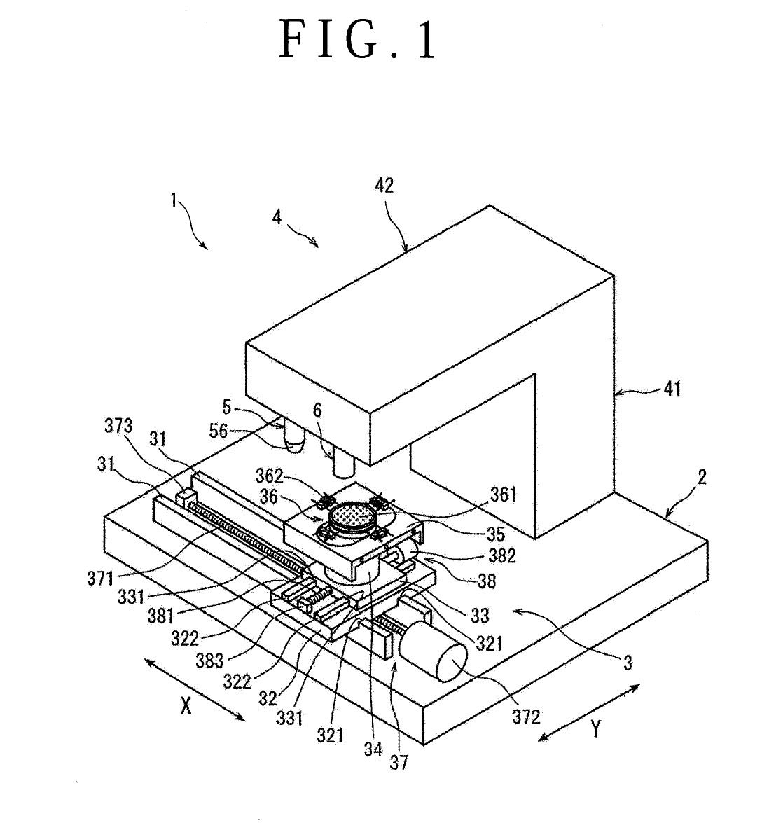

In the following, a preferred embodiment of the laser oscillation mechanism configured in accordance with the present invention is described in detail with reference to the accompanying drawings. FIG. 1 is a perspective view of a laser processing apparatus in which the laser oscillation mechanism according to an embodiment of the present invention is incorporated. A laser processing apparatus 1 depicted in FIG. 1 includes a stationary base 2, a chuck table mechanism 3 disposed for movement in a processing-feeding direction (X-axis direction) indicated by an arrow mark X on the stationary base 2 and configured to hold a workpiece thereon, and a laser beam irradiation unit 4 as laser beam irradiation means disposed on the stationary base 2.

The chuck table mechanism 3 includes a pair of guide rails 31 disposed in parallel along the X-axis direction on the stationary base 2, a first sliding block 32 disposed for movement in the X-axis direction on the pair of guide rails 31, a second sliding block 33 disposed for movement in a Y-axis direction indicated by an arrow mark Y orthogonal to the X-axis direction on the first sliding block 32, a support table 35 supported by a cylindrical member 34 on the second sliding block 33, and a chuck table 36 as workpiece retention means. The chuck table 36 includes an absorption chuck 361 configured from a porous material, and, for example, a circular semiconductor wafer which is a workpiece is held by suction means not depicted on a holding face which is an upper face of the absorption chuck 361. The chuck table 36 configured in such a manner as just described is rotated by a stepping motor not depicted disposed in the cylindrical member 34. It is to be noted that a clump 362 for fixing an annular frame for supporting a workpiece such as a semiconductor wafer through a protective tape is disposed on the chuck table 36.

The first sliding block 32 includes a pair of guiding target grooves 321 provided on the lower face thereof for fitting with the pair of guide rails 31 and a pair of guide rails 322 formed in parallel along the Y-axis direction and provided on the upper face thereof. The first sliding block 32 configured in such a manner as just described is configured for movement in the X-axis direction along the pair of guide rails 31 by fitting the guiding target grooves 321 with the pair of guide rails 31. The chuck table mechanism 3 includes X-axis direction moving means 37 for moving the first sliding block 32 in the X-axis direction along the pair of guide rails 31. The X-axis direction moving means 37 includes an external thread rod 371 disposed in parallel to and between the pair of guide rails 31 and a driving source such as a stepping motor 372 for driving the external thread rod to rotate. The external thread rod 371 is supported at one end thereof for rotation on a bearing block 373 fixed to the stationary base 2 and transmission-coupled at the other end thereof to an output power shaft of the stepping motor 372. It is to be noted that the external thread rod 371 is screwed into a penetrating internal thread hole formed on an external thread block not depicted provided in a projecting manner on the lower face of a central portion of the first sliding block 32. Accordingly, by driving the external thread rod 371 for forward rotation and reverse rotation by the stepping motor 372, the first sliding block 32 is moved in the X-axis direction along the guide rails 31.

The second sliding block 33 includes a pair of guiding target grooves 331 provided on the lower face thereof for fitting with the pair of guide rails 322 provided on the upper face of the first sliding block 32, and is configured for movement in the Y-axis direction by fitting the guiding target grooves 331 with the pair of guide rails 322. The chuck table mechanism 3 includes Y-axis direction moving means 38 for moving the second sliding block 33 in the Y-axis direction along the pair of guide rails 322 provided on the first sliding block 32. The Y-axis direction moving means 38 includes an external thread rod 381 disposed in parallel to and between the pair of guide rails 322 and a driving source such as a stepping motor 382 for driving the external thread rod 381 to rotate. The external thread rod 381 is supported at one end thereof for rotation on a bearing block 383 fixed to the upper face of the first sliding block 32 and transmission-coupled at the other end thereof to an output power shaft of the stepping motor. It is to be noted that the external thread rod 381 is screwed in a penetrating internal screw hole formed on an internal screw block not depicted provided in a projecting manner on the lower face of a central portion of the second sliding block 33. Accordingly, by driving the external thread rod 381 for forward rotation and reverse rotation by the stepping motor 382, the second sliding block 33 is moved in the Y-axis direction along the guide rails 322.

The laser beam irradiation unit 4 includes a support member 41 disposed on the stationary base 2, a casing 42 supported by the support member 41 and extending substantially in a horizontal direction, laser beam irradiation means 5 disposed on the casing 42, and image pickup means 6 disposed at a front end portion of the casing 42 for detecting a processing region for which laser processing is to be performed. It is to be noted that the image pickup means 6 includes illumination means for illuminating a workpiece, an optical system for capturing a region illuminated by the illumination means, an image pickup device (CCD) for picking up an image captured by the optical system, and so forth.

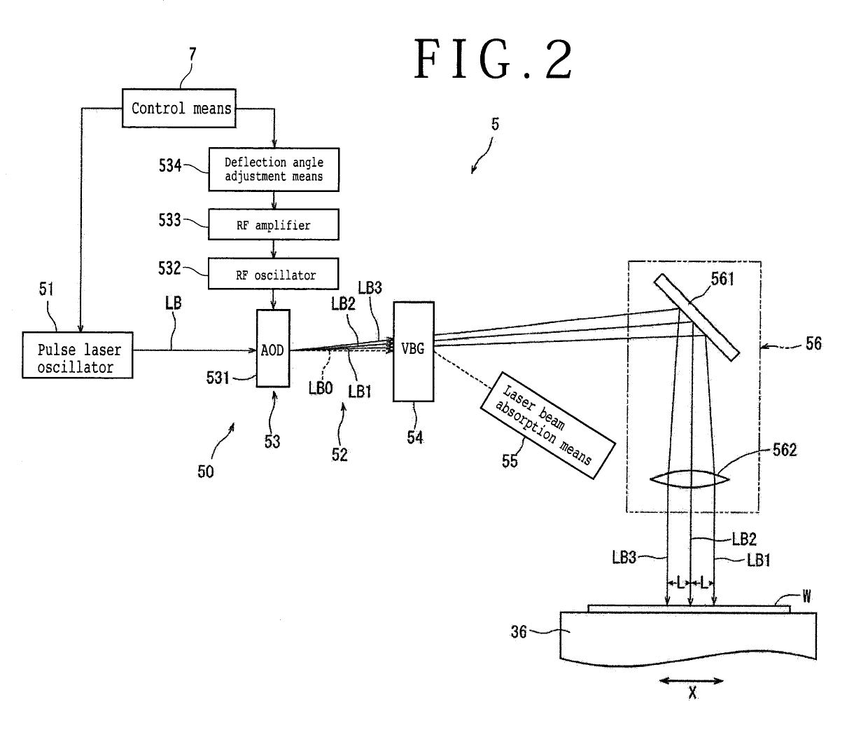

The laser beam irradiation means 5 is described with reference to FIG. 2. The laser beam irradiation means 5 includes a laser oscillation mechanism 50 and a condenser 56. The laser oscillation mechanism 50 is configured from a pulse laser oscillator 51 for oscillating a pulse laser, and optical path changing means 52 for changing the angle of an optical path of the pulse laser beam oscillated by the pulse laser oscillator 51. In the present embodiment, the pulse laser oscillator 51 oscillates a pulse laser beam LB of a wavelength (for example, 355 nm) having absorbability for a workpiece formed, for example, from a silicon wafer. The pulse laser oscillator 51 is controlled by control means 7.

The optical path changing means 52 which configures the laser beam irradiation means 5 is configured from acousto-optic deflection means 53 for changing the optical path of the pulse laser beam LB oscillated by the pulse laser oscillator 51 in an effective region, and a volume Bragg grating (VBG) 54 for refracting a pulse laser beam desired to be excluded from within the pulse laser beam whose angle of the optical path is changed by the acousto-optic deflection means 53 to exclude the desired pulse laser beam from within the effective region.

The acousto-optic deflection means 53 includes an acousto-optic device (AOD) 531 for cooperating with a direction conversion mirror hereinafter described of the condenser 56 to change the optical path of the pulse laser beam LB oscillated by the pulse laser oscillator 51 to the X-axis direction, an RF oscillator 532 for generating an RF (radio frequency) signal to be applied to the acousto-optic device (AOD) 531, a first RF amplifier 533 for amplifying the power of the RF signal generated by the RF oscillator 532 and applying the resulting RF signal to the acousto-optic device (AOD) 531, and deflection angle adjustment means 534 for adjusting the frequency of the RF signal to be generated by the RF oscillator 532. The acousto-optic device (AOD) 531 can adjust the angle when the direction of the optical path of the laser beam is to be changed in accordance with the frequency of the RF signal to be applied. The deflection angle adjustment means 534 described above is controlled by the control means 7.

The acousto-optic deflection means 53 is configured in such a manner as described above, and an action of the acousto-optic deflection means 53 is described below. The pulse laser beam LB oscillated by the pulse laser oscillator 51 is introduced to the acousto-optic device (AOD) 531 configuring the acousto-optic deflection means 53. The pulse laser beam LB introduced to the acousto-optic deflection means 53 is outputted as zero-order light LB0 if a voltage of, for example, 0 V is applied to the acousto-optic device (AOD) 531 by the deflection angle adjustment means 534 of the acousto-optic deflection means 53 which is controlled by the control means 7. Then, the pulse laser beam LB introduced to the acousto-optic device (AOD) 531 changes the direction of the optical path such that it becomes a pulse laser beam LB1 if a voltage of, for example, 5 V is applied to the acousto-optic device (AOD) 531 by the deflection angle adjustment means 534, becomes a pulse laser beam LB2 if a voltage of 10 V is applied, and becomes a pulse laser beam LB3 if a voltage of 15 V is applied.

In the present embodiment, the volume Bragg grating (VBG) 54 which configures the optical path changing means 52 refracts, from among the zero-order light LB0 and the pulse laser beams LB1, LB2, and LB3 the direction of the optical paths of which has been changed by the acousto-optic device (AOD) 531 which configures the acousto-optic deflection means 53, the zero-order light LB0 toward laser beam absorption means 55 disposed at a position displaced from the effective region as indicated by a broken line. Then, the volume Bragg grating (VBG) 54 introduces the pulse laser beams LB1, LB2, and LB3, the direction of the optical paths of which has been changed, to the condenser 56. In this manner, since the zero-order light LB0 desired to be excluded is refracted toward the laser beam absorption means 55 disposed at a position displaced from the effective region by the volume Bragg grating (VBG) 54, the volume Bragg grating (VBG) 54 can be disposed in a neighboring relationship with the acousto-optic device (AOD) 531 which configures the acousto-optic deflection means 53. Therefore, upsizing of the apparatus can be prevented.

The condenser 56 includes a direction conversion mirror 561 for downwardly converting the direction of the pulse laser beams LB1, LB2, and LB3 introduced by the volume Bragg grating (VBG) 54 and a telecentric fθ lens 562 for condensing the pulse laser beams LB1, LB2, and LB3 whose direction has been converted by the direction conversion mirror 561. In the present embodiment, the pulse laser beams LB1, LB2, and LB3 condensed by the telecentric fθ lens 562 are condensed in a predetermined spaced relationship by a distance (L) from each other in the X-axis direction as depicted in FIG. 2.

The direction of the optical path of the pulse laser beam LB is successively changed to those of the pulse laser beams LB1, LB2, and LB3 by the acousto-optic device (AOD) 531 which configures the acousto-optic deflection means 53 as described above. Then, the pulse laser beams LB1, LB2, and LB3 are successively condensed by the telecentric fθ lens 562 and then irradiated on a workpiece W held on the chuck table 36. Then, the chuck table 36 is processing-fed at a predetermined processing speed corresponding to the distance (L) described above in a leftward direction in FIG. 2 so that processing can be performed for the same processing position of the workpiece W.

Although the present invention has been described in connection with the embodiment depicted in the drawings, the present invention is not limited to the embodiment but can be modified in various manners in accordance with the subject matter of the present invention. For example, in the embodiment described hereinabove, an example is described wherein the laser oscillation mechanism according to the present invention is applied to the laser processing apparatus, the laser oscillation mechanism according to the present invention can be applied to laser equipment other than the laser processing apparatus.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A laser oscillation mechanism comprising:
a pulse laser oscillator configured to oscillate a pulse laser beam; and
optical path changing means for changing an angle of an optical path of the pulse laser beam oscillated by the pulse laser oscillator,
wherein the optical path changing means includes
acousto-optic deflection means including an acousto-optic device for changing the optical path of the pulse laser beam oscillated by the pulse laser oscillator within an effective region, and
a volume Bragg grating configured to exclude, from among pulse laser beams obtained by changing an angle of the optical path of the pulse laser beam by passing through said acousto-optic device, a pulse laser beam desired to be eliminated by refraction from within the effective region.
